(19) United States
(12) Patent Application Publication
(10) Pub. No.: US 2026/0313189 A1
(43) Pub. Date: Oct. 8, 2026

(54) SYSTEM AND METHOD FOR PRESENTING SECONDARY CONTENT ON A SECOND SCREEN OF A DUAL SCREEN DISPLAY SYSTEM

(71) Applicant: Telly, Inc., Sherman Oaks, CA (US)

(72) Inventors: Ilya Pozin, Los Angeles, CA (US); Shervin Pishevar, Miami, FL (US); Eric Loes, Miami, FL (US); Sascha Prueter, Miami, FL (US)

(21) Appl. No.: 19/483,203

(22) PCT Filed: May 9, 2024
(86) PCT No.: PCT/US2024/028608

§ 371 Date: Nov. 10, 2025

Related U.S. Application Data
(60) Provisional application No. 63/465,198, filed on May 9, 2023.

(51) Int. Cl. H04N 21/431; H04N 21/45; H04N 21/472; H04N 21/81

(52) U.S. Cl. CPC H04N 21/4316; H04N 21/4532; H04N 21/472; H04N 21/812

(57) ABSTRACT

According to an embodiment of the present disclosure, a television has two screens that are integrally contained in the housing. One of the screens is the main screen and the second is smaller and may be used to provide additional interactive content related to the content on the main screen, such as relevant advertising or other information related to the type of program or features of the content. For example, a sports program that involves two competing teams may be used to generate information or advertising related to the type of sport, sports generally, or the particular teams or players involved at any given time during the program. The type and feature information associated with the program on the main screen may be obtained from an electronic program guide entry related to the program, from metadata associated with the content, from closed captioning information or from other information included with the program as well as curated content from an editorial team.

### CROSS REFERENCE TO RELATED APPLICATIONS

This application claims the benefit of U.S. Provisional Patent Application No. 63/465,198, entitled “System and Method for Presenting Ads and Information on a Second Screen of a Dual Screen Television Related to Content on the Main Screen,” filed May 9, 2023, which is incorporated by reference herein in its entirety.

### TECHNICAL FIELD

The disclosed implementations relate generally to television displays and, more particularly, to a television that integrates two display portions in a vertical stack that features the ability to present secondary content to users in one screen that is related to a main program being presented in the other.

### BACKGROUND

The proliferation of streaming video applications and the availability of video content online, has led to increased demands being placed on televisions to display traditional television content and make additional streaming or internet-based content available to television users. Television manufacturers also offset the cost of televisions by selling advertising or providing other secondary content.

Limitations of existing televisions, however, lead to clumsy screen overlays used to control the television and present information to users. Secondary content, such as advertisements, is presented on the main screen and either interrupt a program being watched or are presented on a significant portion of the main screen. Both of these techniques interfere with watching a program and may detract from the experience.

Existing televisions generally have incorporated a single display screen to present both television content and secondary content to users. Some televisions have allowed picture in picture for watching programs while navigating menus, and some televisions also offer split screen functionality that allows users to watch more than one television program at a time. However, this functionality has generally been limited to displaying programs, menus and secondary content in the same display, each at a reduced size or in some other predetermined manner.

There is a need for a television that allows the presentation of a television program or streaming content in a main screen, while at the same time presenting related information or advertising in a manner that does not interfere with the main program. There is a further need to determine the type of content and features of the content in the main screen, such as a sports program, a particular sports team, a movie, a tv show, etc., in order to enable the selection and presentation of additional information or advertisements related to such content type and features. There is a further need for a television that maximizes the ability to provide additional information related to content on a main screen in a manner desired by the viewer that does not interfere with the main program and without the shortcomings of conventional televisions.

### SUMMARY

According to an embodiment of the present disclosure, a television has two screens that are integrally contained in the housing. One of the screens is the main screen and the second is smaller and may be used to provide additional interactive content related to the content on the main screen, such as relevant advertising or other information related to the type of program or features of the content. For example, a sports program that involves two competing teams may be used to generate information or advertising related to the type of sport, sports generally, or the particular teams or players involved at any given time during the program. The type and feature information associated with the program on the main screen may be obtained from an electronic program guide entry related to the program, from metadata associated with the content, from closed captioning information or from other information included with the program as well as curated content from an editorial team. An application program may take as inputs the video output, audio output, electronic program guide, closed captioning, or other data sources and use an algorithm or artificial intelligence based process to select content or advertising to present to a user on the second screen.

According to another embodiment of the invention, a television with separate, integrated screen hardware portions within the same housing, comprises: a first screen hardware portion capable of presenting content in a high-definition format: a second screen hardware portion integral with the television, the second screen having the high-definition format and a size that is substantially the same width as the first screen and between ⅓ and ¼ the height; speakers for outputting sound corresponding to content in the first and second screens; a memory for storing program instructions corresponding to applications, including an Ad application and an Ad widget application, and storing advertising data; a remote control capable of controlling both screens; an Ad server, accessible over a network including the Internet, for storing advertisements that may be served to the television; and a processor, coupled with the screens, speakers, memory, remote control, Internet, and the Ad server, the processor capable of (i) executing program instructions for the Ad application and Ad widget application and determining advertising data, including viewer information, demographic information and context information for Ad selection; (ii) transmitting at least the demographic information and context information to the Ad server; (iii) receiving advertisement data corresponding to advertisements from the Ad server and storing the advertisement data in an ad carousel; (iv) presenting on the second screen at least one widget card and an Ad widget card based on an advertisements within the Ad carousel; (iv) registering user interaction with the widgets via the remote control and executing widget actions in response to the interaction; and (v) concurrently displaying content on the first screen.

In some embodiments, the user interaction with an interactive Ad widget card causes the Ad widget to expand to a fullscreen experience on the secondary screen. In others, user interaction with an interactive Ad widget card causes the processor to present a corresponding advertisement from the Ad carousel on the first screen and speakers. Selection of an interactive Ad widget card may cause an experience synchronized across both screens. Selection of an interactive Ad widget card may cause the Ad widget to display another advertisement from the Ad carousel and the Ad widget cards may rotate through the ads in the ad carousel. Selection of an interactive Ad widget card may cause an experience of driving application launches or ability to download an application to TV and/or Attached HDMI devices.

The television processor may in some embodiments determine current viewers in front of the television and may select advertisements from the Ad carousel based on the demographics of the current viewers and a number of times current viewers have seen the advertisement. The processor may also select an advertisement from the Ad carousel based on a context of content concurrently being presented in the first screen or second screen, wherein the context includes identifiable information, example being actors, teams, players and objects found within the content. The widgets are selectable and configurable by the user according to preferences and the advertisements selected may correspond to interests reflected in widgets.

According to another embodiment of the invention, a method of operating a television with separate, integrated screen hardware portions in the same housing, includes: presenting with a media processor audio visual content on a first television screen in a high-definition format synchronized with audio presented on a speaker associated with the television; presenting on a second screen integral with the television at least one widget card and an Ad widget card based on advertisements stored within an Ad carousel, the second screen having a high-definition format and a size that is substantially the same width as the first screen and between ⅓ and ¼ the height; outputting sound from speakers based on content presented in the first and second screens; receiving signals from at least one of a remote control and a microphone capable of controlling both screens; determining advertising data, including viewer information, demographic information and context information for Ad selection; transmitting at least the demographic information and context information to an Ad server; receiving advertisement data corresponding to advertisements from the Ad server and storing the advertisement data in the ad carousel; registering user interaction with the widgets via the remote control and executing widget actions in response to the interaction; and concurrently displaying content on the first screen.

According to an embodiment of the invention in which the targeted ad and information system and method finds application, a television provides two integrated television screens.

The lower television screen is approximately ¼ to ⅓ the height of the upper screen which is preferably 16:9. This allows a television viewer to watch a standard 16:9 TV screen while simultaneously interacting with a smaller, lower screen. This arrangement facilitates providing a full range of interactive content, control and features to users via the second screen along with targeted information and advertising related to the type and features of the content being presented on one or both screens.

According to some embodiments, the integrated television screens may comprise separate television panels integrated into a single television, with or without a soundbar. In other embodiments, for example, a single 4:3 panel may be configured with a physical screen divider and software for dividing the video into two separate integrated screens. According to one embodiment, an HDMI port may deliver video to the upper 16:9 section only. In other embodiments, an HDMI port may deliver video to the upper and lower sections.

One general aspect of the present disclosure includes a system for displaying first audiovisual content and second audiovisual content. The system also includes a first screen having a height and a width. The system also includes a second screen. The system also includes a processor, operatively coupled to the first screen and the second screen. The system also includes a user input device. The system also includes a memory for storing program instructions that, when executed by the processor, instruct the processor to:. The system also includes receive user input via the user input device, requesting display, by the system, of the first audiovisual content. The system also includes in response to receiving the user input via the user input device, display the first audiovisual content on the first screen, where the first audiovisual content fills either substantially the entire height or substantially the entire width of the first screen. The system also includes while displaying the first audiovisual content on the first screen, display the second audiovisual content on the second screen, where the second audiovisual content is selected, from a plurality of available second audiovisual content, based on at least one of: information relating to a viewer of the first audiovisual content, and information relating to the first audiovisual content. The system also includes where the second audiovisual content is displayed on the second screen (i) without interrupting the display of the first audiovisual content on the first screen, (ii) without covering any portion of the first audiovisual content on the first screen, and (iii) without altering the dimensions of the first audiovisual content displayed on the first screen. Other embodiments of this aspect include corresponding computer systems, apparatus, and computer programs recorded on one or more computer storage devices, each configured to perform the actions of the methods.

Implementations may include one or more of the following features. The system where the program instructions, when executed by the processor, further instruct the processor to: receive a second user input via the user input device, representing a user interaction with the second audiovisual content; in response to the second user input, display third audiovisual content on the first screen, the third audiovisual content being related to the second audiovisual content, the third audiovisual content being separate and distinct from the first audiovisual content. The information relating to the first audiovisual content is obtained from at least one of: an electronic program guide entry related to the first audiovisual content, metadata associated with the first audiovisual content, and closed captioning information included with the first audiovisual content. The program instructions, when executed by the processor, further instruct the processor to: initially display the second audiovisual content at a reduced size; receive a second user input via the user input device, representing a user interaction with the second audiovisual content; and in response to the second user input. display the second audiovisual content on the second screen, at a full size relative to the second screen. The program instructions, when executed by the processor, further instruct the processor to: receive a third user input via the user input device, representing a user interaction with the second audiovisual content; in response to the third user input, display third audiovisual content on the first screen, the third audiovisual content being related to the second audiovisual content, the third audiovisual content being separate and distinct from the first audiovisual content. The program instructions, when executed by the processor, further instruct the processor to: receive a fourth user input via the user input device, representing a user interaction with the third audiovisual content on the first screen; in response to the fourth user input, execute a command on the system. The command is to launch an application stored in the memory. The command is to download an application to the memory. The second audiovisual content includes a plurality of widgets, and where the program instructions, when executed by the processor, further instruct the processor to receive a second user input via the user input device, representing a user interaction to indicate a choice of a chosen widget of the plurality of widgets; and in response to the second user input, display third audiovisual content, on the second screen, relating to the chosen widget, where the third audiovisual content fills either substantially the entire height or substantially the entire width of the second screen. Implementations of the described techniques may include hardware, a method or process, or computer software on a computer-accessible medium.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 is a diagram of a television that integrates two distinct screens and concurrent functionality according to one aspect of the present disclosure.

FIG. 2 is a block diagram of a television that integrates two distinct screens and concurrent functionality according to one aspect of the present disclosure.

FIG. 3 is a flow diagram of a method of selecting and presenting ads to users in different formats on a first and a second screen of a television that integrates two distinct screens according to one aspect of the present disclosure.

FIG. 4 is a functional block diagram of an application program that determines viewer information and program context to facilitate selecting and presenting ads on a television that integrates two distinct screens according to one aspect of the present disclosure.

FIG. 5 is a functional block diagram of an interaction between an application program and a widget program for presenting ads on a television that integrates two distinct screens and concurrent functionality according to one aspect of the present disclosure.

FIG. 6 depicts an illustration of advertising transitions on a lower screen of an integrated two screen television that displays widgets and ads served by an ad carousel according to one aspect of the present disclosure.

FIG. 7 is a flow diagram of a method in accordance with one aspect of the present disclosure.

### DESCRIPTION OF IMPLEMENTATIONS

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first electronic device could be termed a second electronic device, and, similarly, a second electronic device could be termed a first electronic device, without departing from the scope of the various described implementations. The first electronic device and the second electronic device are both electronic devices, but they are not necessarily the same electronic device.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

According to an embodiment, a television has two screens that are integrally contained in the housing. One of the screens is the main screen. The other is smaller and may be used to provide additional interactive content, such as advertising or other information related to the type of program on the main screen or interests of users of the television.

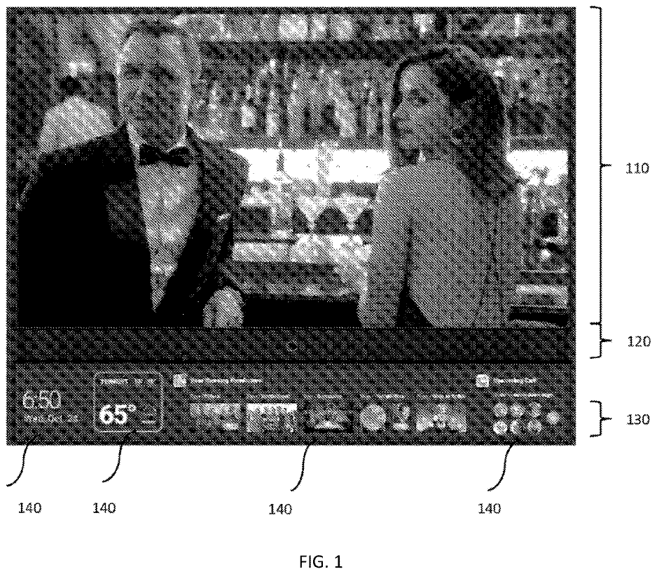

FIG. 1 depicts a television 100 that integrates two distinct screens and concurrent functionality according to an embodiment. Referring to FIG. 1, the television includes an overall housing and an upper screen 110 and a lower screen 130. The upper and lower screen may be separated by an optional sound bar 120. Alternatively, the screens may be separated by a physical divider or placed adjacent to one another. The lower screen may be portioned into areas where the screen output is determined by widget programs 140, that present information, interactive or otherwise to users.

According to an embodiment of the invention, the lower television screen is approximately ¼ to ⅓ the height of the upper TV which preferably has an aspect ratio of 16:9. It will be understood, however, that other dimensions may be chosen for the screen based on design and usage considerations and that these ratios are merely illustrative. This allows a television viewer to watch a standard 16:9 TV screen while simultaneously watching a smaller, lower screen for multitasking. Additionally, the lower screen can be on while leaving the upper screen for media consumption including, but not limited to, text, graphics, advertising, video, and audio. This arrangement facilitates providing a full range of interactive content, control and features to users via the provision of applications that may control either screen or both screens simultaneously. Such applications enable the linking of content, control and features between the two screens and ancillary devices such a sound bar, which may also be integrated into the television.

According to some embodiments, the integrated television screens may comprise separate television panels integrated into a single television, with or without a soundbar. In other embodiments, for example, a single panel having a different aspect ratio, such as a 4:3 panel may be configured with a physical screen divider and hardware and/or software provisioning to divide the television into two separate, but functionally integrated, screens. According to one embodiment, HDMI ports may deliver video to the upper screen only. In other embodiments, the HDMI ports may deliver video to the upper and lower sections. The above embodiments are not limited to HDMI, and can use other physical connectors to allow secondary devices to connect to the TV, e.g. to deliver video and/or audio.

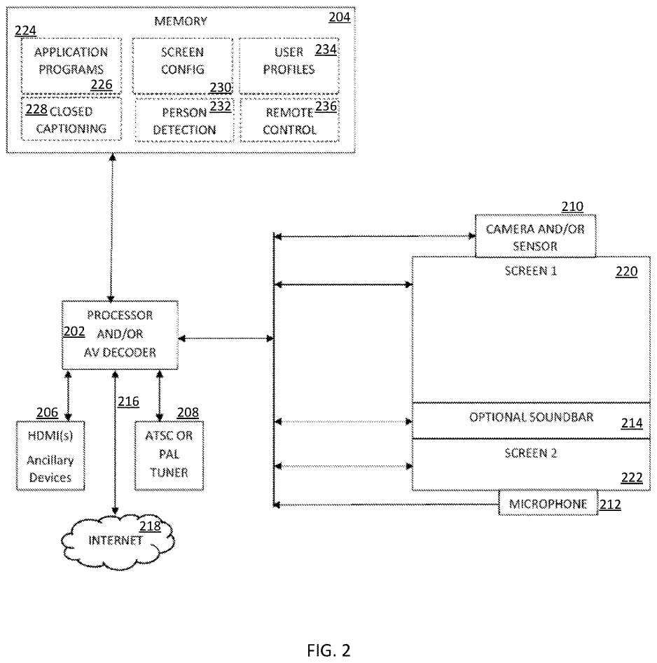

FIG. 2 depicts a functional block diagram of a television 200 that integrates two distinct screens and concurrent functionality according to an embodiment. Referring to FIG. 2, a television 200 according to an embodiment incorporates a processor 202 coupled with a memory 204, HDMI ports 206, USB ports, Audio outports, and an ATSC or PAL tuner 208. A sensor 210, e.g. for detecting the presence of viewers and/or allowing for viewer interactivity, may also be included. The sensor 210 may be a camera, a millimeter wave sensor, a motion sensor, one or more of the above, or other sensors known in the art for detecting the presence of humans. The system may also include a microphone 212, speakers or a soundbar 214, a network interface 216 to facilitate access to a network such as the Internet 218, and a first screen 220 and a second screen 222 as described above. The memory 204 may store programs 224 that include program instructions that are executed by the processor 202 to enable the various functionalities of the television. The memory may include, for example, application programs 226, a closed captioning program 228, a screen configuration program 230, a person detection program 232, a user profile program 234, and a remote control program 236, among others.

The HDMI ports 206 enable A/V devices to be connected to the television, including DVD players, DVRs, sound bars, streaming boxes, A/V Receivers, gaming consoles and other equipment. USB ports may also be present, which would enable USB devices to be connected to the television, including USB thumb drives, media players and other equipment. Audio output ports may also be present, to enable external audio devices, such as speakers, headphones, and audio/video receivers, to be connected. ATSC or PAL tuners 208 may be incorporated into the television to allow the television to receive over the air or certain cable broadcasts and present them on the main screen 220, or on the secondary screen 222.

Microphone 212 may be included in the television 200 to allow the user to provide spoken commands to the television 200, to allow for video conferencing, and to allow other audio visual applications. Sensor 210 may also be provided to facilitate functionality such as determining the number of viewers of the television, to permit video conferencing, and for gesture and motion recognition, among other features.

The first screen 220 and the second screen 222 are distinct from one another, and render images corresponding to content from the HDMI ports, from the tuners, from the Internet, streaming or other interconnected devices. In addition, the content of the screens 220 and 222 may be determined by application programs 224 or any of the other programs stored in memory 204 and executed by the processor 202. The speakers and/or soundbar 212 are used to provide audio output corresponding to content displayed on one or both of the screens 222 and 224, or enabled through the application programs or other programs provided on the television 200. The television 200 may also incorporate an RF receive or IR port for receiving signals from a user input device, such as a remote control, used to control the television.

Processor 202 may be a single microprocessor, multiple processors, or a processor and a co-processor. Persons having skill in the art will realize that references herein to “a processor” or “the processor” may actually refer to more than one processor acting together. In one embodiment, a primary microprocessor may be used to render and operate the user interface while a second processor might be used to decode video, for example H.264 format outputting a signal via HDMI. The processor(s) 202 may support all functionality needed to operate the display screens of the television, and synchronize images with audio output, including rendering, video decoding, audio decoding, audio visual synchronization control, motion estimation and motion compensation, picture quality, timestamp normalization, frame rate control, and over the air updates.

In addition, the processor(s) 202 execute program instructions 224 from memory 204 to enable applications to be presented on one or both screens 220 and 222 of the television 200, and to permit use of the speakers 214, microphone 212, cameras and/or other sensors 210, internet connection 218, remote control, and two-way communication with ancillary devices connected to the television, such as content streaming hardware.

According to an embodiment, the processor 202 may be an application processor designed specifically for smart display applications such as the A311D2 processor, and may include, for example, CPU/GPU subsystems, video codecs, graphics subsystems, video engines, video/graphics output pipelines, HDMI receiver ports, demultiplexers for broadcast and streaming video, digital signal processors (DSPs) for processing audio, peripheral interfaces such as for Ethernet, USB, Bluetooth, SDIO 3.0, eMMC 5.1, SDIO/SD card controller, UART, I2C, high-speed SPI PWMs and an IR blaster. The processor 202 may be distributed or a system on a chip and may interface with additional memory 204 and components of the television 200.

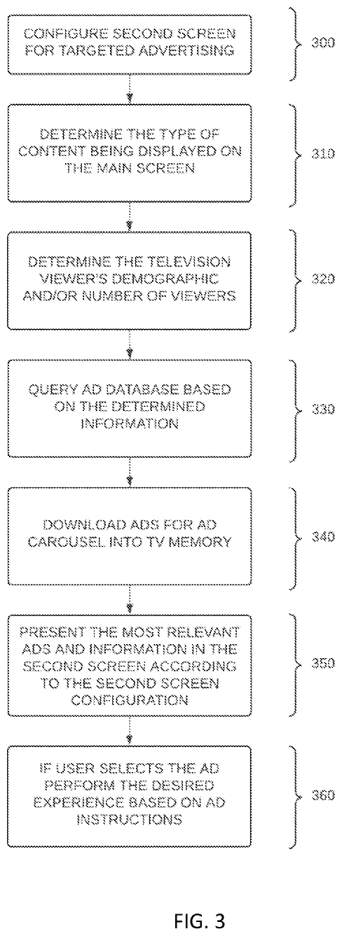

FIG. 3 depicts a method of selecting and presenting alternative content, such as advertising, to users in different formats on a first and/or second screen of a television that integrates two distinct hardware screens or one hardware screen divided up by software according to an embodiment. In 300, the screen configuration is determined for the second screen of the television. The second screen may be partitioned into segments into which widget cards, which deliver targeted information to users, are placed. Widget cards enable the presentation of sports, news, weather, time or other information to users. Users are able to: select the types of widgets that they want displayed, and customize the widgets by geographic areas in the case of time and/or weather or other regionally focused widgets; customize widgets by type of information, for example by news outlet or type of news for news widgets; or customize widgets with sports teams or players for sports focused widgets, including fantasy leagues. Widgets may be static or dynamic. When more information than the space available is present, a widget card may cycle through presenting the information. Interactive widget cards may expand in size or expand to a widget page to take the entire width of the screen once selected. This allows a more robust interaction with the information source. The configuration of the second screen reflects the user's choices of widgets, widget configuration, applications, and other settings. The second screen also includes a portion that is allocated to advertising. According to an embodiment, one widget page is allocated to advertisements, but any number of widget pages may be allocated to advertising and the advertisement may be expanded to encompass the entire second screen or all or portions of the main screen.

In 310, a secondary content application resident in memory, executed by the processor, will determine the type of content being displayed on the main screen or second screen. This may include the name of the content, such as a TV show or movie title, a genre such as sports or specific sports, or demographic information about the content being viewed. This information may be obtained from a content recognition system, electronic program guide, closed captioning information or other data associated with content.

In 320, the secondary content application determines the viewer's demographic and/or the number of viewers in front of the television. This may be determined in a variety of ways. According to one way, a single user of the television maintains a profile on the television and that profile identifies demographic information of the user. The television may maintain a database of user profiles, or such a database may be stored elsewhere, e.g. on a server over the internet, accessible via the television. In another way, the television incorporates a camera or other viewer sensor. The sensor may be used to determine the number of viewers in front of the television.

Demographic information for the user may also be stored in a database on the television and/or on a server accessed via the network. User profiles may contain information previously acquired from the user, e.g. during device activation. User profiles may also contain information available from third parties. User profile information may be used to determine optimal secondary content for each delivery of an ad from the ad server. The user's associated demographic may be used to determine ads that will be presented.

For example, and without limitation, ads may be determined (i) based only on a user being present; (ii) based on multiple users being present including the primary user; (iii) based on multiple users being present not including the primary user; and (iv) based on a single user being present that is not the primary user. Known users of the television may have their demographic information stored in connection with their profile, which may also include an indication of which ads they have seen and when they have seen the ads or how many times they have seen the ads. The profile may include an indication of which content they have viewed on the device and when they have viewed that content and how many times that may also influence the ads seen on the secondary display.

In 330, the secondary content application may query a database using demographic information and activity data of the viewers determined in 320, and the content being viewed on the primary screen. The database may return multiple pieces of secondary content to the television, which may be stored, e.g. in memory, as secondary content. Alternatively, the server may periodically push secondary content to the television. In 340 items of secondary content are placed in a carousel for viewing by television viewers. Secondary content may be selected from the carousel, or for placement in the carousel, based on who is in front of the television at any given time, and how many times each particular ad has been seen.

In 350, the secondary content application selects an item of secondary content from the carousel and displays it in a widget page area or in an expanded area of the second screen. Secondary content may be audiovisual content, which persons having skill in the art may realize, may contain either visual content, audio content, or both. In a preferred embodiment, primary audiovisual content, displayed on a primary screen, may contain both audio and visual content, while secondary content, on the secondary screen, may present visual content only, so as not to interrupt the audio of the primary content.

A single item of secondary content may be displayed for a period of time in a widget page slot, and may be expanded and then returned to a widget slot or perform the intended requirements of the advertisement being displayed. The next item in the carousel may replace a prior ad and cycle through the widget page, and present its display requirements for presentation to the user. Secondary content may be interactive, such that when the user selects the secondary content, the secondary content may expand in the second screen and provide audio visual content to the user.

In 360, the secondary content may expand to the main screen, e.g. in response to user interactivity, which may occur via a user input device such as a remote control. When the secondary content expands to, or moves to, the main screen, the secondary content may also provide audio content in addition to visual content on the primary screen. Secondary content may be found at a link or deep link stored in the carousel, or the content itself may be stored in the ad carousel. The secondary content may include A/V content in both the second screen or the main screen when selected, according to desired configurations. The secondary content may present the ability for direct user input using the TV remote control, allowing a user to fill in a survey or fill out a form on the television. Interactivity of this type may occur on either screen.

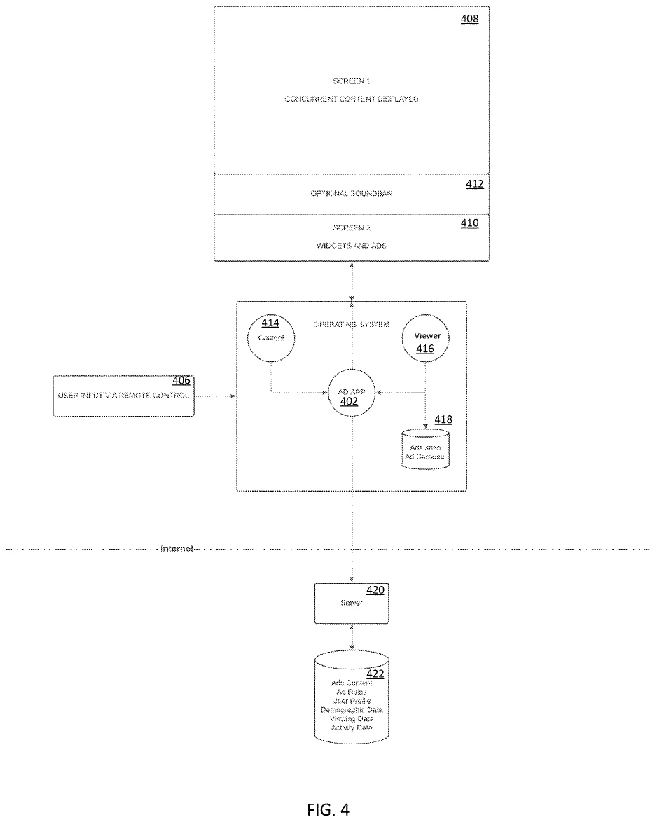

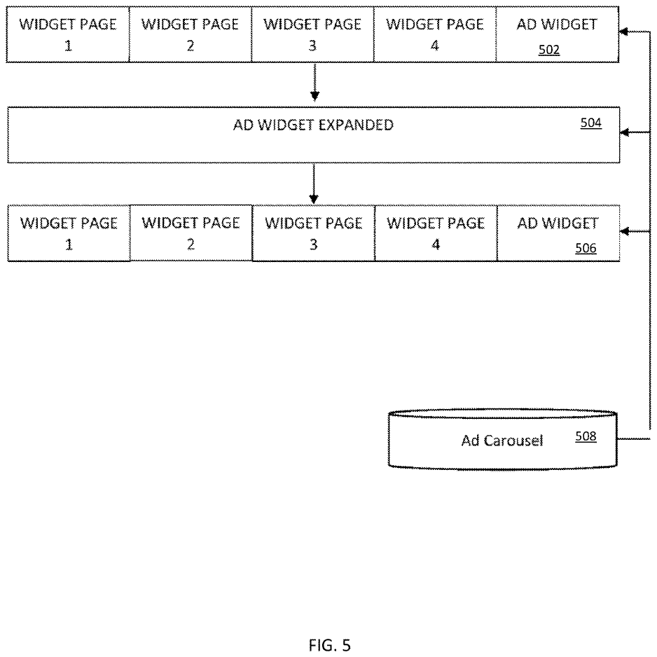

FIG. 4 is a block diagram of an application program 402 for secondary content delivery, that determines viewer information and program context to facilitate selecting and presenting secondary content on the second screen 410 of a television 404 that integrates two distinct screens. Referring to FIG. 4, a user input device, such as a remote control 406, may be used to interact with the television 404 to determine content displayed in the main screen 408. Remote control button commands, or voice commands, e.g. received by a microphone coupled to either the television 404 or the remote control 406, may also be used to interact with widgets displayed on the second screen 410, which may include interactive widgets. The display of the secondary content application 402 may also include a widget program, which may be resident in memory coupled to the television 404, that is configured to display secondary content on the second screen 410 as described above. The secondary content may be interactive. When the interactive content is selected, the widget may cause the secondary content to expand to a larger size on the second screen 410. Interaction between the user and the secondary content may also cause additional content relating to the secondary content to launch on the main screen 408 and/or the speakers 412. User interactions may also cause the application 402 to perform the intended instructions required based on the requirements of the interactive content. Instructions may include instructions relating to the television system itself, including launching an application stored in memory, or downloading an application to memory.

The secondary content application 402 may also be coupled to a database 414, which may be stored in a memory coupled to the television 404. The content database 414 may include data used to facilitate selection and storage of secondary content for display. The secondary content application 402 may also be coupled to a database of viewers, including viewer data 416, both current and known, context information about the main screen including demographic information or content title, or if the main screen is off, information about the user's widgets on the second screen 410.

The secondary content application 402 may also include and/or be linked to a carousel database 418 that comprises links to secondary content available on the Internet, links to content available via a streaming service, or the actual content itself, stored locally. The content, and/or links, may be stored in a designated order and the secondary content application may step through the choices in the carousel as they are each presented to the user. The options may be changed based on who is in the room and/or the active user profile at the time. Options could also rotate in set or variable intervals or based on profile, distance from the screen, or other factors.

Secondary content application 402 may also interact with a back end server 420 over the Internet. Back end server 420 may contain a database 422, which may contain information relating to secondary content, demographic information associated with secondary content, secondary content rules, user viewing and activity data. Any collection of data may be stored in a backend database and leveraged for determining the best advertisements to be shown to those currently present in physical proximity to the TV. Data may include data relating to primary content, secondary content and user information. Other data may also be stored at back end server 420.

The secondary content application 402 may be in communication with back end server 420. The communication may be constant, periodic, sporadic, or otherwise. The server may receive, from the secondary content application 402, demographic information for one or more viewers and information about the content or context of the content being viewed on the main screen. Based on that information received, the back end server 420 may determine one or more ads to serve to the television's secondary content application 402. Received secondary content and rules may be transmitted to the television 404, at which they may be stored in carousel database 418 and used by the secondary content application 402 to present secondary content to viewers on the second screen 410 or main screen 408. Secondary content may also use the television speakers or optional sound bar 412.

Application programs may be configured to display secondary content via widgets on the second screen 410. The widget output may include widget cards and widget pages, which each present secondary content on the second screen 410 for the user in a way that does not interfere with content presented on the main screen 408. Widget cards may have a predetermined width that presents information to the user that takes up a portion of the second screen 410. Widgets may take up to the entire width of the secondary screen 410. Each widget card or page presents a view of the secondary content to the user. The user may select a widget to interact with them. User interaction may cause the widget to expand, or may cause the secondary content, or other content related to the secondary content, to display on the main screen 408. Additional experiences may also occur. The secondary content may come from content stored in the carousel or may come from links or deep links to the ad content found on the Internet or via a streaming device connected to the television.

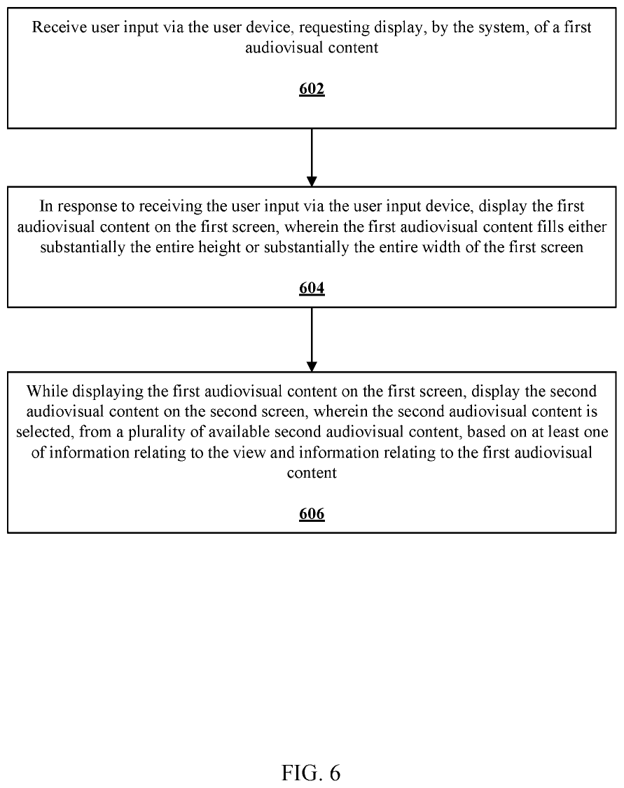

FIG. 6 is a block diagram illustrating transitions on a lower screen of an integrated two screen television. Referring to FIG. 6, the lower screen, e.g. lower screen 410 of FIG. 4, is shown to start with five widget cards 502, the right most of which is a card that presents a secondary content, e.g. an ad, to the user. The next view 504 shows a transition where the widget cards are replaced by a widget page that has expanded to take up the entire lower screen. The last view 506 shows that the lower screen has returned to a view showing five widget cards including the widget card in the right most position. The secondary content program uses the carousel database 508 to populate the secondary content for the widget cards and the widget page in each of these views, and the Advertisement selected may change over time according to the cards in the carousel.

FIG. 7 is a flow diagram of a method 600 of displaying first audiovisual content and second audiovisual content, on a system having first screen, a second screen, a processor operatively coupled to the first screen and the second screen, a user input device, and a memory, for storing program instructions that, when executed by the processor, instruct the processor to perform the method 600.

At operation 602, the method includes receiving user input via the user input device, requesting display, by the system, of the first audiovisual content. For example, the system may receive button commands from remote control 406. At operation 604, the method further includes, in response to receiving the user input via the user input device, displaying (604) the first audiovisual content on the first screen, wherein the first audiovisual content fills either substantially the entire height or substantially the entire width of the first screen. For example, in response to the button commands from remote control 406, a first audiovisual content may display on first screen 408.

The method further includes, while displaying the first audiovisual content on the first screen, displaying (606) the second audiovisual content on the second screen. For example, while the chosen, first, audiovisual content is displayed on first screen 408, second audiovisual content, e.g. and advertisement or an advertising widget, may be shown on second screen 410. The second audiovisual content is selected from a plurality of available second audiovisual content, e.g. content stored at content database 414. The second audiovisual content may be chosen from the plurality of available second audiovisual content, based on information relating to a viewer of the first audiovisual content, such as user profiles via a user profile application 234. The second audiovisual content may also be chosen based on information relating to the first audiovisual content. Information relating to the first audiovisual content may be identified using various methods as described herein, including an electronic program guide entry related to the first audiovisual content, metadata associated with the first audiovisual content, and closed captioning information included with the first audiovisual content, as discussed above with reference to FIG. 3.

The second audiovisual content is displayed on the second screen (i) without interrupting the display of the first audiovisual content on the first screen, (ii) without covering any portion of the first audiovisual content on the first screen, and (iii) without altering the dimensions of the first audiovisual content displayed on the first screen.

In some embodiments, the method may also include receiving a second user input via the user input device, representing a user interaction with the second audiovisual content, and, in response to the second user input, displaying third audiovisual content on the first screen, the third audiovisual content being related to the second audiovisual content, the third audiovisual content being separate and distinct from the first audiovisual content. For example, user interaction with an ad, while it is on on the second screen 410 may cause content, related to the ad, to appear on the first screen 408.

In some embodiments, the system may also include a sensor, such as sensor 210, which may be used to detect the presence of a view in physical proximity to the system, and to capture identifying information of the viewer. The method may also include selecting the second audiovisual content based on information relating to the viewer, which may include identifying the viewer detected by the sensor, based on a comparison between the identifying information and a viewer database, such as viewer data 416. In some embodiments, the sensor is further configured to detect a number of a plurality of viewers in physical proximity to the system. The method may further include choosing the second audiovisual content, from the plurality of second audiovisual content choices, based on the demographic information from at least two of the plurality of viewers.

In some embodiments, the method may also include initially displaying the second audiovisual content at a reduced size, e.g. as a widget such as widget 502 of FIG. 6. The method may also include receiving a second user input via the user input device, representing a user interaction with the second audiovisual content, and, in response to the second user input, displaying the second audiovisual content on the second screen, at a full size relative to the second screen, such as that shown as expanded widget 504 in FIG. 6.

In some embodiments, the method may also include receiving a third user input via the user input device, representing a user interaction with the second audiovisual content, in response to the third user input, displaying third audiovisual content on the first screen, the third audiovisual content being related to the second audiovisual content, the third audiovisual content being separate and distinct from the first audiovisual content.

In some embodiments, the method may also include receiving a fourth user input via the user input device, representing a user interaction with the third audiovisual content on the first screen, and, in response to the fourth user input, executing a command on the system. The command may be to launch an application stored in the memory 204. The command may also be to download an application to the memory 204.

In some embodiments, the second audiovisual content includes a plurality of widgets, such as widgets 502 in FIG. 6. The method may also include receiving a second user input via the user input device, representing a user interaction to indicate a choice of a chosen widget of the plurality of widgets, and, in response to the second user input, displaying third audiovisual content, on the second screen, relating to the chosen widget, wherein the third audiovisual content, e.g. expanded widget 504, fills either substantially the entire height or substantially the entire width of the second screen.

While particular embodiments have been shown and described herein, it will be understood by those having ordinary skill in the art that changes may be made to those embodiments without departing from the spirit and scope of the invention.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations are chosen in order to best explain the principles underlying the claims and their practical applications, to thereby enable others skilled in the art to best use the implementations with various modifications as are suited to the particular uses contemplated.

What is claimed is:

1. A system for displaying first audiovisual content and second audiovisual content, comprising:
a first screen having a height and a width;
a second screen;
a processor, operatively coupled to the first screen and the second screen;
a user input device;
a memory for storing program instructions that, when executed by the processor, instruct the processor to:
receive user input via the user input device, requesting display, by the system, of the first audiovisual content;
in response to receiving the user input via the user input device, display the first audiovisual content on the first screen, wherein the first audiovisual content fills either substantially the entire height or substantially the entire width of the first screen;
while displaying the first audiovisual content on the first screen, display the second audiovisual content on the second screen, wherein the second audiovisual content is selected, from a plurality of available second audiovisual content, based on at least one of: information relating to a viewer of the first audiovisual content, and information relating to the first audiovisual content;
wherein the second audiovisual content is displayed on the second screen (i) without interrupting the display of the first audiovisual content on the first screen, (ii) without covering any portion of the first audiovisual content on the first screen, and (iii) without altering the dimensions of the first audiovisual content displayed on the first screen.

2. The system of claim 1, wherein the program instructions, when executed by the processor, further instruct the processor to:
receive a second user input via the user input device, representing a user interaction with the second audiovisual content;
in response to the second user input, display third audiovisual content on the first screen, the third audiovisual content being related to the second audiovisual content, the third audiovisual content being separate and distinct from the first audiovisual content.

3. The system of claim 1, wherein the information relating to the first audiovisual content is obtained from at least one of: an electronic program guide entry related to the first audiovisual content, metadata associated with the first audiovisual content, and closed captioning information included with the first audiovisual content.

4. The system of claim 1, wherein the program instructions, when executed by the processor, further instruct the processor to:
initially display the second audiovisual content at a reduced size;
receive a second user input via the user input device, representing a user interaction with the second audiovisual content; and
in response to the second user input, display the second audiovisual content on the second screen, at a full size relative to the second screen.

5. The system of claim 4, wherein the program instructions, when executed by the processor, further instruct the processor to:
receive a third user input via the user input device, representing a user interaction with the second audiovisual content;
in response to the third user input, display third audiovisual content on the first screen, the third audiovisual content being related to the second audiovisual content, the third audiovisual content being separate and distinct from the first audiovisual content.

6. The system of claim 5, wherein the program instructions, when executed by the processor, further instruct the processor to:
receive a fourth user input via the user input device, representing a user interaction with the third audiovisual content on the first screen;
in response to the fourth user input, execute a command on the system.

7. The system of claim 6, wherein the command is to launch an application stored in the memory.

8. The system of claim 6, wherein the command is to download an application to the memory.

9. The system of claim 1, wherein the second audiovisual content includes a plurality of widgets, and wherein the program instructions, when executed by the processor, further instruct the processor to
receive a second user input via the user input device, representing a user interaction to indicate a choice of a chosen widget of the plurality of widgets; and
in response to the second user input, display third audiovisual content, on the second screen, relating to the chosen widget, wherein the third audiovisual content fills either substantially the entire height or substantially the entire width of the second screen.

10. A method of displaying first audiovisual content and second audiovisual content on a television, the television having a first screen having a height and a width, a second screen, a processor, operatively coupled to the first screen and the second screen, a user input device, and a memory, the method comprising the steps of:
receiving user input via the user input device, requesting display, by the system, of the first audiovisual content;
in response to receiving the user input via the user input device, displaying the first audiovisual content on the first screen, wherein the first audiovisual content fills either substantially the entire height or substantially the entire width of the first screen;
while displaying the first audiovisual content on the first screen, displaying the second audiovisual content on the second screen, wherein the second audiovisual content is selected, from a plurality of available second audiovisual content, based on at least one of: information relating to a viewer of the first audiovisual content, and information relating to the first audiovisual content;
wherein the second audiovisual content is displayed on the second screen (i) without interrupting the display of the first audiovisual content on the first screen, (ii) without covering any portion of the first audiovisual content on the first screen, and (iii) without altering the dimensions of the first audiovisual content displayed on the first screen.
